(19) United States
(12) Patent Application Publication
(10) Pub. No.: US 2019/0239678 A1
(43) Pub. Date: Aug. 8, 2019

(54) INSTANT HEATING SMART MILK MAKER

(71) Applicant: SHENZHEN QIANHAI ZOOME TECHNOLOGY CO., LTD., Shenzhen, Guangdong (CN)

(72) Inventors: Yusheng Cao, Shenzhen, Guangdong (CN); Deyan Cheng, Shenzhen, Guangdong (CN); Yongtao Chen, Shenzhen, Guangdong (CN); Jinming Yin, Shenzhen, Guangdong (CN)

(21) Appl. No.: 16/341,920

(22) PCT Filed: Jul. 17, 2017
(86) PCT No.: PCT/CN2017/093177

§ 371 Date: Apr. 15, 2019

(30) Foreign Application Priority Data
Oct. 14, 2016 (CN) 201610899788.3

(51) Int. Cl. A47J 31/40; A47J 31/44; A47J 31/46; A47J 31/52

(52) U.S. Cl. CPC A47J 31/404; A47J 31/4457; A47J 31/5253; A47J 31/462; A47J 31/468; A47J 31/461

(57) ABSTRACT

An instant heating smart milk maker includes a body, and a powdered milk charge metering device, a powdered milk brewing device, a water tank, a hot water supply device, a control circuit board, and a powdered milk feeder drive device mounted on the body. The hot water supply device and the powdered milk feeder drive device are electrically connected to the control circuit board. The powdered milk charge metering device includes a driving shaft, a powdered milk supply impeller and a powdered milk box. The powdered milk supply impeller is connected to the powdered milk feeder drive device in a transmission way through the driving shaft. An powdered milk inlet of the powdered milk brewing device is connected to a powdered milk outlet of the powdered milk box. The water tank is connected to a water inlet of the hot water supply device.

### FIELD OF THE INVENTION

This invention relates to the technical field of powder beverage brewing devices, and in particular, to an instant heating smart milk maker.

### BACKGROUND OF THE INVENTION

In daily life, powdered milk is a common food for peoples, especially for infants and the elderly who eat powdered milk more frequently. The related brewing of powdered milk is filling powdered milk and warm water into a baby bottle and then mixing to form mixed milk solution by manual operation. Because it is difficult to accurately control the amount of powdered milk and water by manual operation, desired milk concentration cannot be ensured. In addition, whether canned or bagged powdered milk is in use, it needs to open the cover or tear the bag in each time, which results in exposing of the powdered milk to the air, thus the powdered milk is easy to be polluted by environment, and the shelf life of the powdered milk is shorten. Further, brewing of powdered milk includes many processes, which is time-consuming and trouble.

In order to solve the above problems, semi-automatic or automatic milk makers are invented. However, hot water supply of the related semi-automatic or automatic milk makers are generally constant temperature type, i.e., a heater is arranged in a water tank to keep the water of the water tank always at a set temperature. Thus, the heater needs to work repeatedly for a long time during non-brewing milk, which not only wastes electric energy, but also easily to cause damage of the heater. In addition, the water in the water tank is heated repeatedly for a long time, which results in deterioration of the water quality, finally affecting a quality of the brewing milk. In addition, when the related semi-automatic or automatic milk makers are used to brewing powdered milk by adding hot water, an outlet of the powdered milk box is easy to be affected by vapor, which results in damped, caked, and mildewed of the powdered milk.

### SUMMARY OF THE INVENTION

Thus, a main object of the present invention is to provide an instant heating smart milk maker, which realizes instant heating of hot water during automatic brewing of powdered milk, thereby saving electric energy and avoiding deterioration of the water quality caused by repeated heating of the water in the tank water, and avoiding flowing of the vapor to the inlet of the powdered milk box to cause damped and caked of the powdered milk.

The above instant heating smart milk maker, which supplies predetermined amount of powdered milk automatically through the powdered milk charge metering device 2 and realizes instant heating of hot water through the hot water supply device 5, can save electric energy and avoid deterioration of the water quality caused by repeated heating of the water in the tank water, and can automatically adjust concentration of the powdered milk through controlling supply of the amount of powdered milk and hot water. In addition, the vapor generated in the mixing chamber 300 during brewing milk can be discharged to the outside of the body 1 through the vapor outlet 303, which avoids damped and caked at the powdered milk outlet 231 of the powdered milk box 23.

For realizing the above object, the present invention provides an instant heating smart milk maker. The instant heating smart milk maker comprises a body, and a powdered milk charge metering device, a powdered milk brewing device, a water tank, a hot water supply device, a control circuit board, and a powdered milk feeder drive device mounted on the body. The hot water supply device and the powdered milk feeder drive device are electrically connected to the control circuit board. The powdered milk charge metering device comprises a driving shaft, a powdered milk supply impeller, and a powdered milk box. The powdered milk supply impeller is connected to the powdered milk feeder drive device in a transmission way through the driving shaft, and a bottom of the powdered milk box forms an powdered milk outlet. The brewing device forms a mixing chamber, a powdered milk inlet, a feed-water inlet, a vapor outlet, and a liquid outlet, the powdered milk inlet of the powdered milk brewing device is connected to the powdered milk outlet of the powdered milk box, the water tank is connected to a water inlet of the hot water supply device, a water outlet of the hot water supply device is connected to the feed-water inlet of the powdered milk brewing device, the liquid outlet is out of the body, and the vapor outlet connects the mixing chamber and the outside of the main boy for discharging the vapor generated in the mixing chamber to the outside of the body.

Preferably, the powdered milk feeder drive device comprises a motor, a Hall sensor, a rotating metering plate, and a plurality of magnets, a rotating shaft of the motor is connected to the driving shaft, the powdered milk supply impeller forms a plurality of powdered milk holes, the magnets are arranged on the rotating metering plate, a number of the magnets and distributions of the magnets are in accordance with the number and distributions of the powdered milk holes, respectively, and the Hall sensor is connected to the control circuit board electrically and induces the magnets.

Preferably, the powdered milk brewing device comprises a brewing funnel bracket, a brewing funnel, and a funnel cover, the vapor outlet is defined in the brewing funnel bracket, the feed-water inlet and the liquid outlet are defined in the brewing funnel, the powdered milk inlet is defined in the funnel cover, the funnel cover further forms a vapor baffle and a vapor exit, the vapor baffle is located between the powdered milk inlet and the vapor exit, for avoiding the vapor generated in the mixing chamber to get into the powdered milk inlet and guiding the vapor to the vapor outlet and finally to the outside of the body by the vapor exit.

Preferably, the powdered milk charge metering device further comprises a mixing rod, a top end of the driving shaft extends upwardly into the powdered milk box and connects to the mixing rod in a transmission way, a bottom end of the driving shaft forms a first guiding member, the powdered milk feeder drive device is arranged under the powdered milk box, and a top end of the powdered milk feeder drive device forms a second guiding member, which matches with the first guiding member and aligns automatically.

Preferably, the hot water supply device comprises a heater, a water pump, and a check valve connected in serious in the waterway, an inlet temperature sensor and an outlet temperature sensor are respectively arranged at an inlet side and an outlet side of the heater in the waterway, a thermal cutoff is formed on a surface of the heater, the heater, the water pump, the check valve, the inlet temperature sensor, and the outlet temperature sensor are connected to the control circuit board electrically.

Preferably, the heater comprises a water pipe and a heating pipe, the water pipe and the heating pipe both are spiral and parallel to each other, the water pipe and the heating pipe are coated with aluminum and die-cast together, the hot water supply further comprises a power supply, and two ends of the heating pipe are connected to the power supply electrically.

Preferably, a rotating grid number of the rotating metering plate of the powdered milk feeder drive device is fed back to a main control chip of the control circuit board in real time, and the rotating grid number of the rotating metering plate is controlled by adjusting the main control chip of the control circuit board, thereby controlling the amount of the powdered milk.

Preferably, the body comprises a separated photoelectric liquid level sensor for detecting water level, the water tank has an optical vertebra arranged at a position corresponding to the separated photoelectric liquid level sensor, and the separated photoelectric liquid level sensor is connected to the control circuit board electrically.

Preferably, the body comprises a photoelectric induction switch for detecting a milk container, the photoelectric induction switch comprises an infrared light transmitter and an infrared light receiver, the infrared light transmitter and infrared light receiver are separated by a black foam, and the photoelectric induction switch is connected to the control circuit board electrically.

Preferably, the body comprises a microswitch for detecting whether the water tank is installed in place, and the microswitch is connected to the control circuit board electrically.

Preferably, a bottom of the powdered milk supply impeller forms a plurality of dividing strips which are radically extended, an angle between two neighboring dividing strips is less than 90 degrees, and the dividing strips does not extend through the geometric center of the powdered milk supply impeller.

Preferably, the liquid outlet of the brewing funnel forms at least three guiding ribs at an inner surface thereof, avoiding dispersing and splashing of the mixed milk solution discharged from the liquid outlet.

The instant heating smart milk maker of the present invention, which supplies predetermined amount of powdered milk automatically through the powdered milk charge metering device and realizes instant heating of hot water through the hot water supply device, can save electric energy and avoid deterioration of the water quality caused by repeated heating of the water in the tank water, and can automatically adjust concentration of the powdered milk through controlling supply of the amount of powdered milk and hot water. In addition, the vapor generated in the mixing chamber 300 during brewing milk can be discharged to the outside of the body 1 through the vapor outlet 303, which avoids damped and caked at the powdered milk outlet 231 of the powdered milk box 23.

### BRIEF DESCRIPTION OF THE DRAWINGS

FIG. 1 is an assembled, perspective view of an instant heating smart milk maker according to an embodiment of the present invention.

FIG. 2 is a top plan view of the instant heating smart milk maker of FIG. 1.

FIG. 3 is a cross-sectional view of the instant heating smart milk maker of FIG. 2, taken along line A-A.

FIG. 4 is an exploded, schematic view of the instant heating smart milk maker of FIG. 1, and shows along with a water tank, a photoelectric induction switch, and a control circuit board.

FIG. 5 is an exploded, schematic view of a powdered milk charge metering device of the instant heating smart milk maker of FIG. 1.

FIG. 6 is an exploded, schematic view of a powdered milk brewing device of the instant heating smart milk maker of FIG. 1.

FIG. 7 is an exploded, schematic view of a powdered milk feeder drive device of the instant heating smart milk maker of FIG. 1.

FIG. 8 is an exploded, schematic view of a hot water supply device of the instant heating smart milk maker of FIG. 1.

FIG. 9 is a schematic view of a bottom of a powdered milk supply impeller of the powdered milk charge metering device of FIG. 5.

FIG. 10 is a schematic view of a liquid outlet of a brewing funnel of the powdered milk brewing device of FIG. 6.

The realization of the purpose, functional characteristics and advantages of the present invention will now be more particularly described, by way of example only, with reference to the accompanying drawings.

### DETAILED DESCRIPTION OF THE EMBODIMENTS

It should be understood that the embodiments described herein are only used to explain the invention, and should not limit the scope of the present invention in any way.

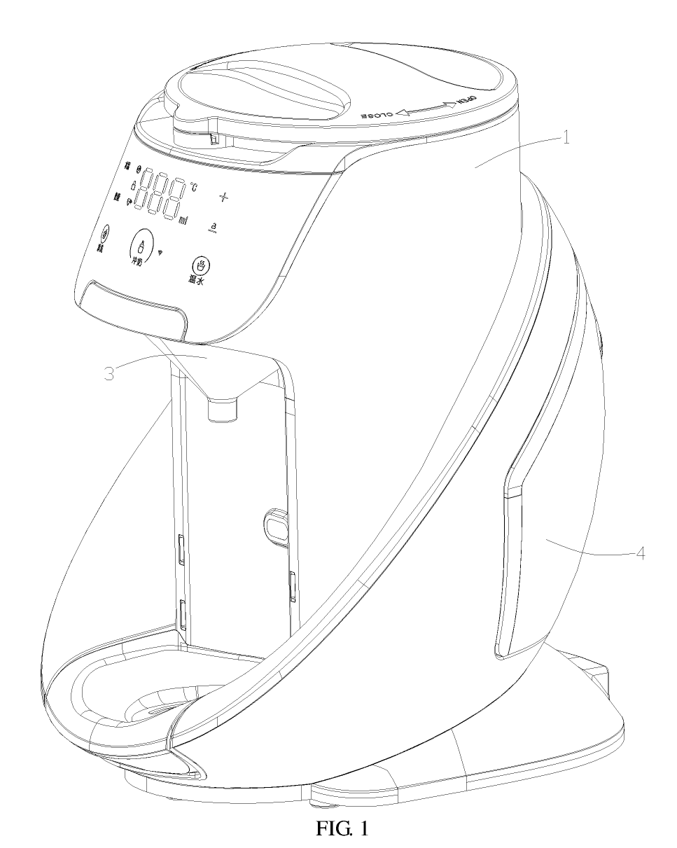

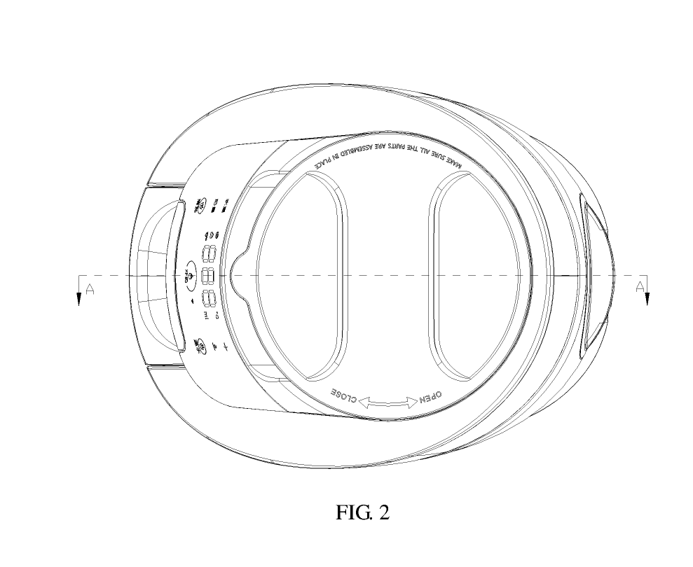

The present invention provides an instant heating smart milk maker. As shown in FIG. 1 to FIG. 10, the instant heating smart milk maker according to an embodiment of the present invention includes a body 1, and a powdered milk charge metering device 2, a powdered milk brewing device 3, a water tank 4, a hot water supply device 5, a control circuit board 6, and a powdered milk feeder drive device 7 mounted on the body 1. The hot water supply device 5 and the powdered milk feeder drive device 7 are electrically connected to the control circuit board 6, respectively. The powdered milk charge metering device 2 includes a driving shaft 21, a powdered milk supply impeller 22, and a powdered milk box 23. The powdered milk supply impeller 22 is connected to the powdered milk feeder drive device 7 in a transmission way through the driving shaft 21. A bottom of the powdered milk box 23 forms an powdered milk outlet 231. The brewing device 3 forms a mixing chamber 300, a powdered milk inlet 301, a feed-water inlet 302, a vapor outlet 303, and a liquid outlet 304. The powdered milk inlet 301 of the powdered milk brewing device 3 is connected to the powdered milk outlet 231 of the powdered milk box 23. The water tank 4 is connected to a water inlet 501 of the hot water supply device 5, and a water outlet 502 of the hot water supply device 5 is connected to the feed-water inlet 302 of the powdered milk brewing device 3. The liquid outlet 304 is formed out of the body 1, for discharging mixed milk solution which is formed by mixing of powdered milk and water. The vapor outlet 303 connects the mixing chamber 300 and the outside of the body 1, for discharging the vapor generated in the mixing chamber 300 to the outside of the body 1.

The above instant heating smart milk maker, which supplies predetermined amount of powdered milk automatically through the powdered milk charge metering device 2 and realizes instant heating of hot water through the hot water supply device 5, can save electric energy and avoid deterioration of the water quality caused by repeated heating of the water in the tank water, and can automatically adjust concentration of the powdered milk through controlling supply of the amount of powdered milk and hot water. In addition, the vapor generated in the mixing chamber 300 during brewing milk can be discharged to the outside of the body 1 through the vapor outlet 303, which avoids damped and caked at the powdered milk outlet 231 of the powdered milk box 23.

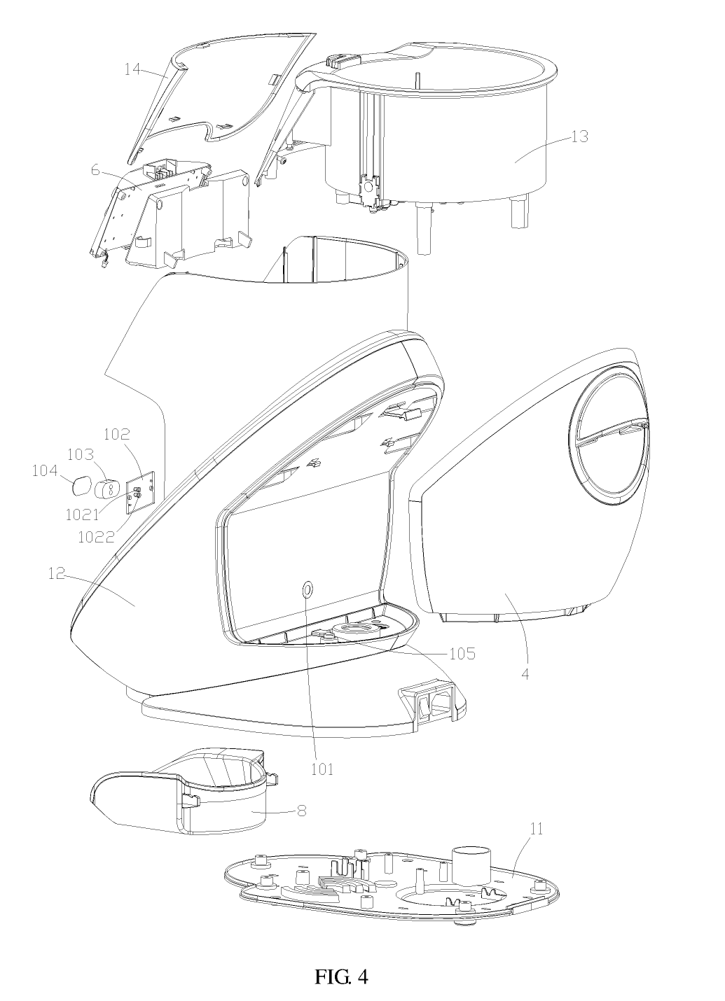

As shown in FIG. 4, is this embodiment, the body 1 includes a base 11, a main body 12, and a head 13. The main body 12 is arranged on the base 11, the head 13 is arranged on the main body 12, and the head 13 has a panel 14 mounted thereon.

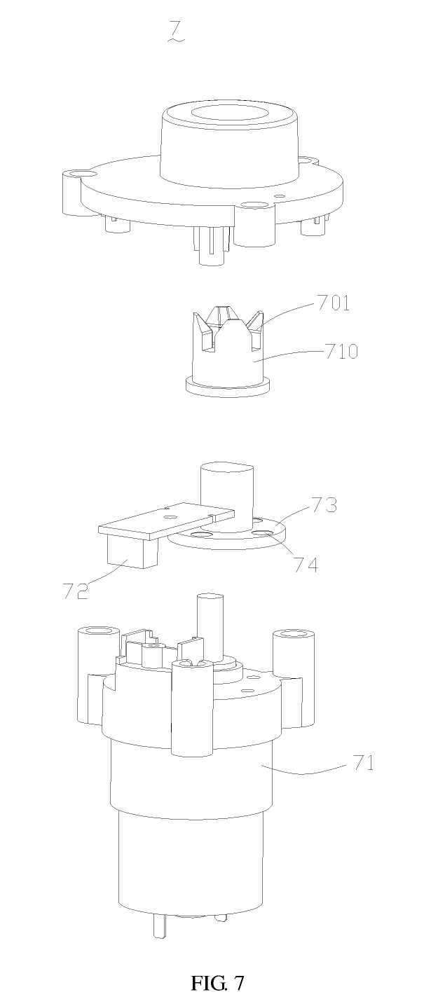

As shown in FIG. 7, in this embodiment, the powdered milk feeder drive device 7 includes a motor 71, a Hall sensor 72, a rotating metering plate 73, and a plurality of magnets 74. A rotating shaft 710 of the motor 71 is connected to the driving shaft 21. The powdered milk supply impeller 22 defines a plurality of powdered milk holes 221. The magnets 74 are arranged on the rotating metering plate 73. A number of the magnets 74 and distributions of the magnets 74 are in accordance with the number and distributions of the powdered milk holes 221, respectively. The Hall sensor 72 is connected to the control circuit board 6 electrically and induces the magnets 74. A rotating grid number of the rotating metering plate 73 of the powdered milk feeder drive device 7 is fed back to a main control chip of the control circuit board 6 in real time, and the rotating grid number of the rotating metering plate 73 is controlled by adjusting the main control chip of the control circuit board 6, thereby controlling the amount of the powdered milk.

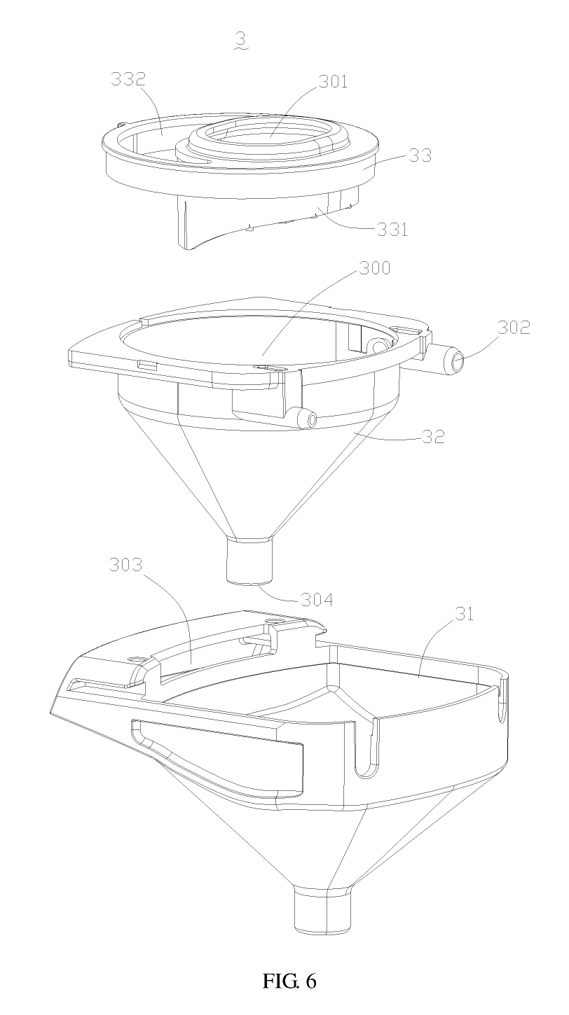

As shown in FIG. 6, in this embodiment, the powdered milk brewing device 3 includes a brewing funnel bracket 31, a brewing funnel 32, and a funnel cover 33. The vapor outlet 303 is defined in the brewing funnel bracket 31. The feed-water inlet 302 and the liquid outlet 304 are defined in the brewing funnel 32. The powdered milk inlet 301 is defined in the funnel cover 33. The funnel cover 33 further includes a vapor baffle 331 and a vapor exit 332. The vapor baffle 331 is located between the powdered milk inlet 301 and the vapor exit 332, avoiding the vapor generated in the mixing chamber 300 to get into the powdered milk inlet 301, and guiding the vapor to the vapor outlet 303 and finally to the outside of the body 1 by the vapor exit 332.

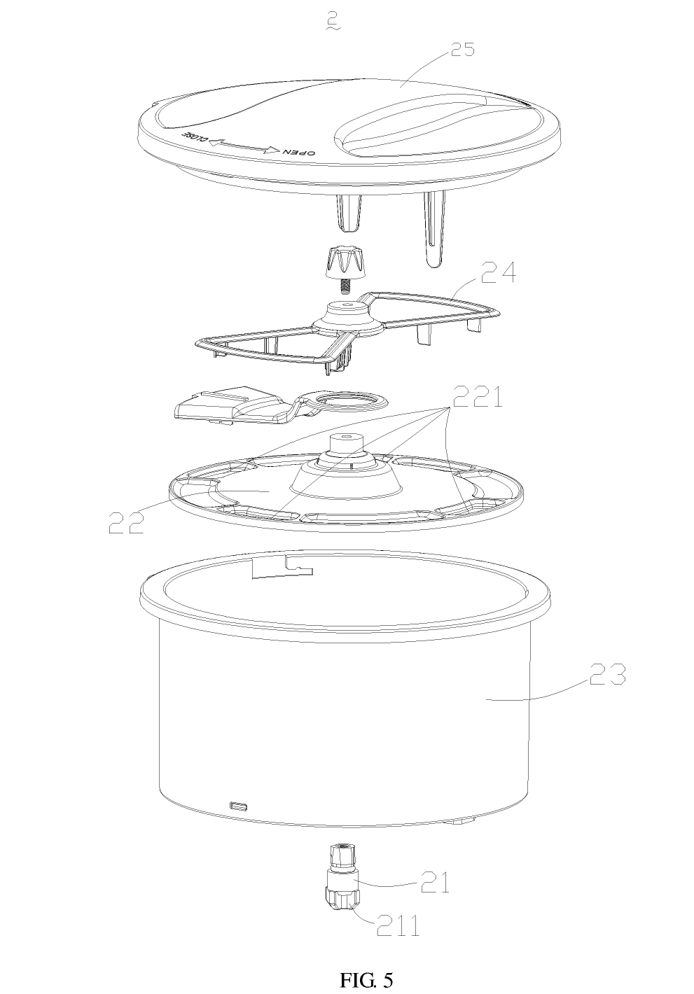

As shown in FIG. 5, in this embodiment, the powdered milk charge metering device 2 further includes a mixing rod 24. A top end of the driving shaft 21 extends upwardly into the powdered milk box 23 and connects to the mixing rod 24 in a transmission way. A bottom end of the driving shaft 21 forms a first guiding member 211. The powdered milk feeder drive device 7 is arranged under the powdered milk box 23, and a top end of the powdered milk feeder drive device 7 forms a second guiding member 701, which matches with the first guiding member 211 and aligns automatically.

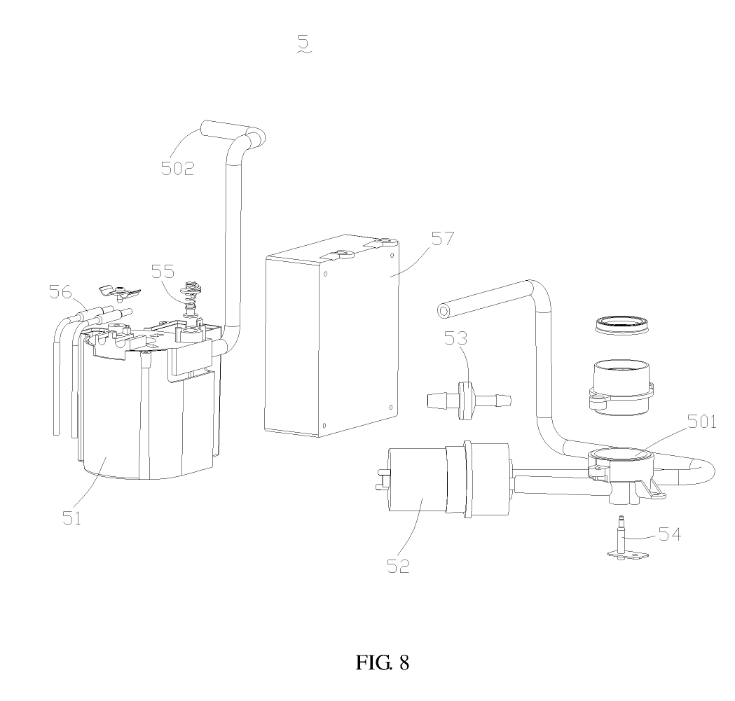

As shown in FIG. 8, in this embodiment, the hot water supply device 5 includes a heater 51, a water pump 52, and a check valve 53 connected in serious in the waterway. In the waterway, an inlet temperature sensor 54 and an outlet temperature sensor 55 are arranged at an inlet side and an outlet side of the heater 51, respectively. A thermal cutoff 56 is formed on a surface of the heater 51. The heater 51, the water pump 52, the check valve 53, the inlet temperature sensor 54, and the outlet temperature sensor 55 are all connected to the control circuit board 6 electrically.

The heater 51 includes a water pipe and a heating pipe. The water pipe and the heating pipe both are spiral and parallel to each other. The water pipe and the heating pipe are coated with aluminum and die-cast together. The hot water supply device 5 further includes a power supply 57. Two ends of the heating pipe are connected to the power supply 57 electrically. Cold water in the water tank 4 flows into the heater 51 through an inlet of the water pipe, and then is heated by the heating pipe of the heater 51, and finally flows out through an outlet of the water pipe of the heater 51 with predetermined temperature.

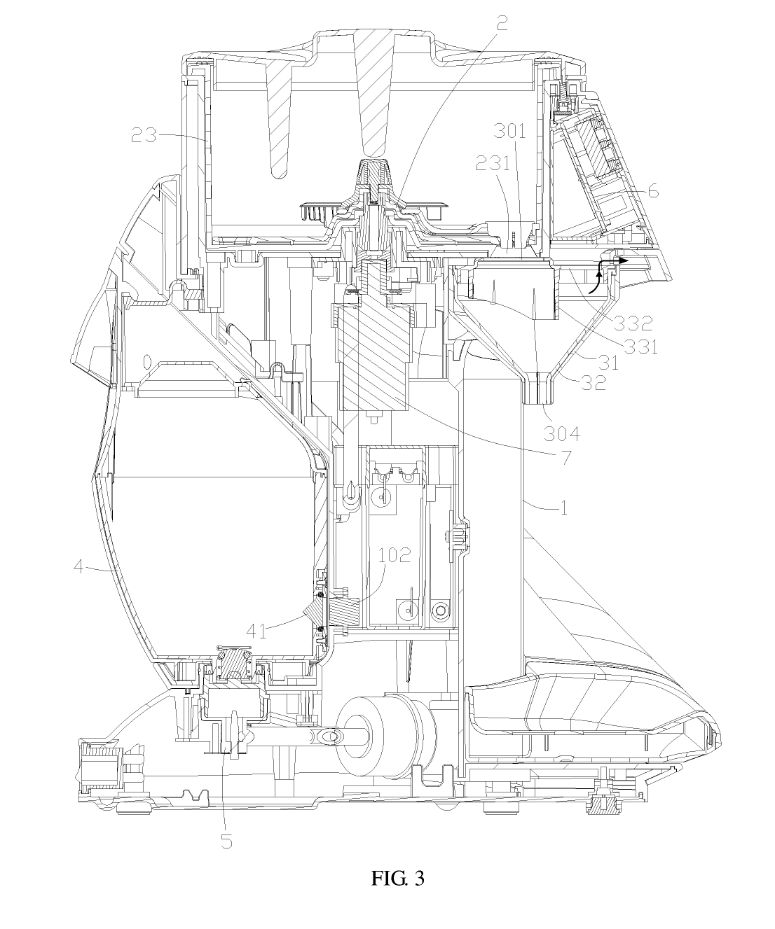

As shown in FIG. 3 and FIG. 4, as an improvement, the body 1 is provided with a separated photoelectric liquid level sensor 101 for detecting water level. The water tank 4 is provided with an optical vertebra 41 at a position corresponding to the separated photoelectric liquid level sensor 101. The separated photoelectric liquid level sensor 101 is connected to the control circuit board 6 electrically. The optical vertebra 41 is fed back to the separated photoelectric liquid level sensor 101 through water wave refraction, thus to correctly judge the water level.

As shown in FIG. 3 and FIG. 4, as an improvement, the body 1 is provided with a photoelectric induction switch 102 for detecting a milk container. The photoelectric induction switch 102 includes an infrared light transmitter 1021 and an infrared light receiver 1022. The infrared light transmitter 1021 and infrared light receiver 1022 are separated by a black foam 103. The photoelectric induction switch 102 is connected to the control circuit board 6 electrically. In addition, the body 1 further can be provided with a microswitch for detecting whether the powdered milk brewing device 3 is installed in place. The microswitch is connected to the control circuit board 6 electrically.

A powdered milk box cover 25 if arranged on the powdered milk box 23. The body 1 further can be provided with a touch switch for detecting whether the powdered milk box cover 25 is installed in place. The touch switch is connected to the control circuit board 6 electrically.

As shown in FIG. 3 and FIG. 4, as an improvement, the body 1 is provided with a microswitch 105 for detecting whether the water tank 4 is installed in place. The microswitch 105 of the water tank 4 is connected to the control circuit board 6 electrically. The microswitch 102 is on when the water tank 4 is installed in place to press the microswitch 105 downwardly, and the control circuit board 6 informs the buzzer to beep. The microswitch 102 is off when the water tank 4 is removed, and the control circuit board 6 prompts through the indicator light of the panel 14.

As shown in FIG. 3 and FIG. 4, as an improvement, the instant heating smart milk maker further includes a pallet 8 for supporting the milk container. The pallet 8 is disassembly mounted at the outside of the body 1, and a mounting height of the pallet 8 is adjustable.

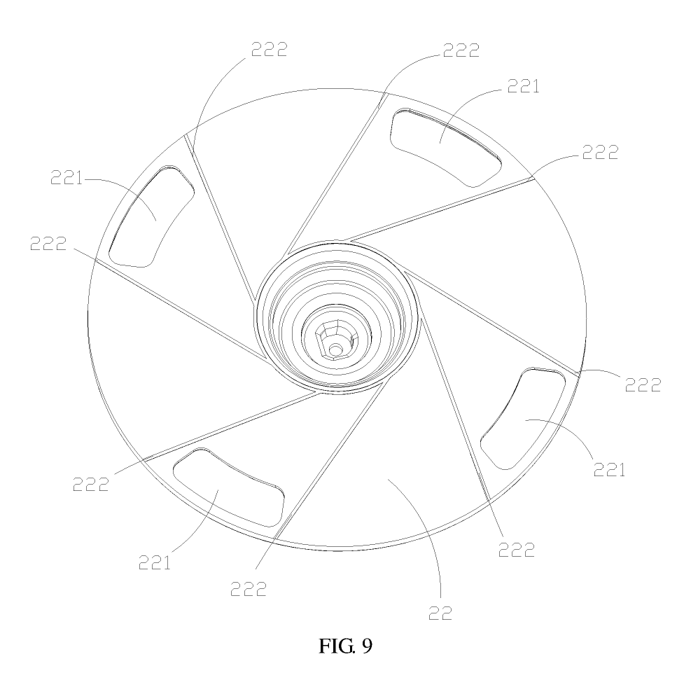

As shown in FIG. 9, as an improvement, a bottom of the powdered milk supply impeller 22 forms a plurality of dividing strips 222 which are radically extended. An angle between two neighboring dividing strips 222 is less than 90 degrees. The dividing strips 222 does not extend through the geometric center of the powdered milk supply impeller 22, and thus the intersection points of the dividing strips 222 periodically and gradually move outwardly from the center, thereby driving the powder at the bottom to move toward the powdered milk outlet 231.

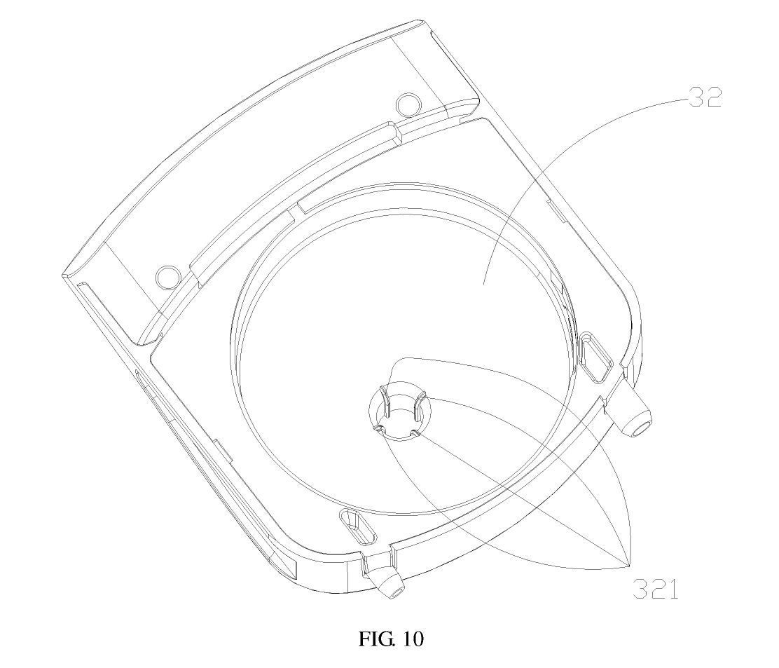

As shown in FIG. 10, as an improvement, the liquid outlet 304 of the brewing funnel 32 forms at least three guiding ribs 321 at an inner surface thereof, avoiding dispersing and splashing of the mixed milk solution discharged from the liquid outlet 304.

The present invention is not limited to the above embodiments. According to the disclosed technical contents of the above embodiments, various other modifications can be apparent. Any equivalent structural transformation according to the contents of the specification and drawings of the present invention, and applying of the present invention to other related technical filed directly or indirectly, should be in the scope of the present invention.

1. An instant heating smart milk maker, wherein the instant heating smart milk maker comprises a body, and a powdered milk charge metering device, a powdered milk brewing device, a water tank, a hot water supply device, a control circuit board, and a powdered milk feeder drive device mounted on the body; wherein the hot water supply device and the powdered milk feeder drive device are electrically connected to the control circuit board; wherein the powdered milk charge metering device comprises a driving shaft, a powdered milk supply impeller, and a powdered milk box, the powdered milk supply impeller is connected to the powdered milk feeder drive device in a transmission way through the driving shaft, and a bottom of the powdered milk box forms an powdered milk outlet; wherein the brewing device forms a mixing chamber, a powdered milk inlet, a feed-water inlet, a vapor outlet, and a liquid outlet, the powdered milk inlet of the powdered milk brewing device is connected to the powdered milk outlet of the powdered milk box, the water tank is connected to a water inlet of the hot water supply device, a water outlet of the hot water supply device is connected to the feed-water inlet of the powdered milk brewing device, the liquid outlet is out of the body, and the vapor outlet connects the mixing chamber and the outside of the main boy for discharging the vapor generated in the mixing chamber to the outside of the body.

2. The instant heating smart milk maker of claim 1, wherein the powdered milk feeder drive device comprises a motor, a Hall sensor, a rotating metering plate, and a plurality of magnets, a rotating shaft of the motor is connected to the driving shaft, the powdered milk supply impeller forms a plurality of powdered milk holes, the magnets are arranged on the rotating metering plate, a number of the magnets and distributions of the magnets are in accordance with the number and distributions of the powdered milk holes, respectively, and the Hall sensor is connected to the control circuit board electrically and induces the magnets.

3. The instant heating smart milk maker of claim 1, wherein the powdered milk brewing device comprises a brewing funnel bracket, a brewing funnel, and a funnel cover, the vapor outlet is defined in the brewing funnel bracket, the feed-water inlet and the liquid outlet are defined in the brewing funnel, the powdered milk inlet is defined in the funnel cover, the funnel cover further forms a vapor baffle and a vapor exit, the vapor baffle is located between the powdered milk inlet and the vapor exit, for avoiding the vapor generated in the mixing chamber to get into the powdered milk inlet and guiding the vapor to the vapor outlet and finally to the outside of the body by the vapor exit.

4. The instant heating smart milk maker of claim 1, wherein the powdered milk charge metering device further comprises a mixing rod, a top end of the driving shaft extends upwardly into the powdered milk box and connects to the mixing rod in a transmission way, a bottom end of the driving shaft forms a first guiding member, the powdered milk feeder drive device is arranged under the powdered milk box, and a top end of the powdered milk feeder drive device forms a second guiding member, which matches with the first guiding member and aligns automatically.

5. The instant heating smart milk maker of claim 1, wherein the hot water supply device comprises a heater, a water pump, and a check valve connected in serious in the waterway, an inlet temperature sensor and an outlet temperature sensor are respectively arranged at an inlet side and an outlet side of the heater in the waterway, a thermal cutoff is formed on a surface of the heater, the heater, the water pump, the check valve, the inlet temperature sensor, and the outlet temperature sensor are connected to the control circuit board electrically.

6. The instant heating smart milk maker of claim 5, wherein the heater comprises a water pipe and a heating pipe, the water pipe and the heating pipe both are spiral and parallel to each other, the water pipe and the heating pipe are coated with aluminum and die-cast together, the hot water supply further comprises a power supply, and two ends of the heating pipe are connected to the power supply electrically.

7. The instant heating smart milk maker of claim 2, wherein a rotating grid number of the rotating metering plate of the powdered milk feeder drive device is fed back to a main control chip of the control circuit board in real time, and the rotating grid number of the rotating metering plate is controlled by adjusting the main control chip of the control circuit board, thereby controlling the amount of the powdered milk.

8. The instant heating smart milk maker of claim 1, wherein the body comprises a separated photoelectric liquid level sensor for detecting water level, the water tank has an optical vertebra arranged at a position corresponding to the separated photoelectric liquid level sensor, and the separated photoelectric liquid level sensor is connected to the control circuit board electrically.

9. The instant heating smart milk maker of claim 1, wherein the body comprises a photoelectric induction switch for detecting a milk container, the photoelectric induction switch comprises an infrared light transmitter and an infrared light receiver, the infrared light transmitter and infrared light receiver are separated by a black foam, and the photoelectric induction switch is connected to the control circuit board electrically.

10. The instant heating smart milk maker of claim 1, wherein the body comprises a microswitch for detecting whether the water tank is installed in place, and the microswitch is connected to the control circuit board electrically.

11. The instant heating smart milk maker of claim 1, wherein a bottom of the powdered milk supply impeller forms a plurality of dividing strips which are radically extended, an angle between two neighboring dividing strips is less than 90 degrees, and the dividing strips does not extend through the geometric center of the powdered milk supply impeller.

12. The instant heating smart milk maker of claim 3, wherein the liquid outlet of the brewing funnel forms at least three guiding ribs at an inner surface thereof, avoiding dispersing and splashing of the mixed milk solution discharged from the liquid outlet.
